(19) United States
(12) Patent Application Publication
(10) Pub. No.: US 2004/0246746 A1
(43) Pub. Date: Dec. 9, 2004

(54) Method for controlling a converter

(76) Inventors: Staffan Norrga, Stockholm (SE); Tomas Jonsson, Vasteras (SE)

Correspondence Address: VENABLE, BAETJER, HOWARD AND CIVILETTI, LLP, P.O. BOX 34385, WASHINGTON, DC, 20043-9998, US

(21) Appl. No.: 10/484,091

(22) PCT Filed: Jun. 19, 2002
(86) PCT No.: PCT/SE02/01195

(30) Foreign Application Priority Data
Jul. 16, 2001 (SE) 0102532-9

(51) Int. Cl. H02M 3/335

(52) U.S. Cl. 363/16

(57) ABSTRACT

The invention relates to a method for controlling a VSC-converter provided with a resonant circuit (16). In connection with the effectuation of an intended commutation process ordered by the modulator (30), the control device (24) is made to send control signals to the current valves (2, 3) and auxiliary valve (18) that are taking part in the commutation process, for turning on or turning off thereof, at instants (t₁) determined on the basis of a desired commutation instant (tₜᵣ) given by the modulator (30) and a calculation algorithm, which is based upon values of the phase current and the intermediate link voltage and knowledge about the influence the components included in the converter have on the intended commutation process, said calculation algorithm being elaborated in consideration of the condition that the desired commutation instant (t*ₜᵣ) is to coincide with an equivalent transition instant (tₜᵣ) for the phase voltage, which equivalent transition instant (tₜᵣ) is estimaged with the aid of knowledge about the influence the components included in the convernter have on the transition of the phase voltage (uₚₕ(t)) during the intended commutation process.

### FIELD OF THE INVENTION AND PRIOR ART

The present invention relates to a method for controlling a VSC-converter.

A VSC-converter for connection between a direct voltage network and an alternating voltage network is previously known e.g. from the thesis “PWM and control of two and three level high voltage” source converters* by Anders Lindberg, Royal Institute of Technology, Stockholm, 1995, in which publication a plant for transmitting electric power through a direct voltage network for high-voltage direct current (HVDC), while utilizing such converters, is described. Before the creation of this thesis, plants for transmitting electric power between a direct voltage network and an alternating voltage network have been based upon the use of network commutated CSC (Current Source Converter)-converters in stations for power transmission. However, in this thesis a totally new concept is described, which is based on instead using VSC (Voltage Source Converter)-converters for forced commutation for transmitting electric power between a direct voltage network being voltage stiff therethrough, in the case in question for high-voltage direct current, and alternating voltage networks connected thereto, which offers several considerable advantages as compared to the use of network commutated CSC-converters in HVDC, among which it may be mentioned that the consumption of active and reactive power may be controlled independently of each other and that there is no risk of commutation faults in the converters and thereby no risk of commutation faults being transmitted between different HVDC-links, as may occur with network commutated CSC:s. Furthermore, it is possible to feed a weak alternating voltage network or a network without any generation of its own (a dead alternating voltage network). There are also further advantages.

A VSC-converter may be included in a plant for transmitting electric power through a direct voltage network for high-voltage direct current (HVDC), in order to e.g. transmit the electric power from the direct voltage network to an alternating voltage network. In this case, the converter has its direct voltage side connected to the direct voltage network and its alternating voltage side connected to the alternating voltage network. The converter may however also be directly connected to a load, such as a high-voltage generator or motor, in which case the converter has either its direct voltage side or its alternating voltage side connected to the generator/motor. The invention is riot limited to these applications; on the contrary, the converter may just as well be used for conversion in a SVC (Static Var Compensator) or a back-to-back-station. The voltages on the direct voltage side of the converter are with advantage high, 10-400 kV, preferably 130-400 kV. The VSC-converter may also be included in other types of FACTS-devices (FACTS=Flexible Alternating Current Transmission) than the ones mentioned above.

In order to limit the turn-off losses in the semiconductor elements of turn-off type of the current valves of the converter, i.e. the losses in the semiconductor elements of turn-off type when these are turned off, it is previously known to arrange capacitive members in the form of so-called snubber capacitors connected in parallel across the respective semiconductor element of turn-off type. It is also known to provide the converter with a so-called resonant circuit for recharging said snubber capacitors in connection with commutation of the phase current. Hereby, it will also be possible to limit the turn-on losses in the semiconductor elements of turn-off type of the current valves, i.e. the losses in the semiconductor elements of turn-off type when these are turned on.

A number of different types of essentially lossless commutation circuits based upon inductances and capacitances have been developed and come into use in order to lower the losses of VSC-converters in connection with commutation. These types of converters are denominated “soft switched converter”. ARCPC-converters (Auxiliary Resonant Commutated Pole Converter) may be mentioned as an example of such converters. These converters comprise a resonant circuit adapted to achieve a recharge of the snubber capacitors of the current valves in connection with commutation of the phase current from a rectifying member of a current valve to a semiconductor element of turn-off type of another current valve so that said semiconductor element can be turned on at low voltage instead of high voltage, whereby the turn-on losses in the semiconductor element of the current valve is limited. The resonant circuit is also used when the phase current is commutated from a semiconductor element of turn-off type of a current valve to a rectifying member of another current valve, i.e. in connection with turn-off of a semiconductor element of the first current valve, when the phase current is so low that the switching time for the voltage in the phase output otherwise would be unreasonably long.

The inventional solution is generally applicable in converters of the type “soft switched converter”, such as for instance in the above mentioned types of converters provided with resonant circuit. As further examples of converter types to which the inventional solution is applicable It may be mentioned three-level ARCP-converters of the type described for instance in “Three Level Auxiliary Resonant Pole Commutated Inverter for High Power Applications”, Cho J G, Baek J W, Yoo D W, Won C Y, IEEE, 1996, and quasi-resonant PWM-converters of the type described for instance in the patent document U.S. Pat. No. 5,572,418.

In a converter that is not provided with any resonant circuit or any snubber capacitors, the commutation of the phase current from for instance a semiconductor element of turn-off type of a first current valve to a rectifying member of a second current valve will in principle take place at the same instant as the semiconductor element of the first current valve is turned off, i.e. the phase voltage will change-over from one pole voltage to the other in principle at the same instant as the first current valve is turned off. There is normally a smaller time delay between the instant when a turn-off signal to a current valve is sent from the control device of the converter and the Instant when the turn-off of the current valve, i.e. the turn-off of the semiconductor element of turn-off type of the current valve, is actually effectuated. If this time delay is disregarded, the control device can in this case consequently be adapted to send a turn-off signal to the outgoing current valve at the desired commutation instant given by the PWM-modulator. At a corresponding commutation in a converter of the type “soft switched converter”, the commutation process will be relatively slow, whereby the change of the phase voltage takes place relatively slowly. Furthermore, the change of the phase voltage during the commutation process will normally not take place linearly in time in a converter of said type. This may result in that the output voltage ordered by the modulator will not be accomplished in a correct manner by the converter, which in its turn may cause the following problems:

Instability in the regulation of the intermediate link voltage and the regulation of the phase current. (The converter is normally included in a regulating circuit for control of these magnitudes.)

Increased content of harmonics in the phase voltage and thereby indirectly in the phase current.

Undesired subharmonics in the phase voltage, which may cause undesired phase currents and saturation of transformers connected to the converter.

Bad utilization of the ability of the converter to deliver phase voltage.

### OBJECT OF THE INVENTION

An object of the present invention is to offer an improved method for controlling a VSC-converter provided with a resonant circuit, which method makes it possible to reduce the above mentioned problems.

### SUMMARY OF THE INVENTION

According to the invention said object is achieved by means of the method according to claim 1.

The inventional solution is based upon the fact that the type of resonant circuit here in question is built up of essentially linear elements, such as inductors and capacitors, which makes it possible to use simple mathematical relationships for determining suitable instants for sending control signals to the current valves and the auxiliary valve. Hereby, it will be possible before the initiation of a commutation to calculate when the different control signals are to be sent to the current valves and auxiliary valve that are taking part in the commutation process, in order for the instant for the transition of the phase voltage from one pole voltage to the other to coincide with desired accuracy with the commutation Instant ordered by the modulator.

According to a preferred embodiment of the invention, the instants for lending control signals to the current valves and the auxiliary valve are calculated with the aid of the value of the voltage across the Intermediate link, the value of the phase current, the value of the snubber capacitance and the value of the inductance of the resonant circuit. Consequently, the instants for sending control signals from the control device are determined on the basis of parameters that are constant or at least essentially constant during the respective commutation process, such as the snubber capacitance and inductance of the resonant circuit, or that vary relatively slowly during the respective commutation process, such as the intermediate link voltage and the phase current, whereby a relatively good accuracy can be obtained in the calculation of said instants.

According to a further preferred embodiment of the invention, the variation of the phase current during the commutation process is taken into consideration in the calculation of said instants. Hereby, a desired precision in the control is obtained. The varying value of the phase current during the commutation process is for instance estimated by means of a linear model of the load connected to the phase output.

Further preferred embodiments of the inventional method will appear from the dependent claims and the subsequent description.

### BRIEF DESCRIPTION OF THE DRAWING

The invention will in the following be more closely described by means of embodiment examples, with reference to the appended drawing. It Is shown in:

FIG. 1 a simplified circuit diagram illustrating a converter according to a first embodiment,

FIG. 2 a simplified circuit diagram illustrating a converter according to an alternative embodiment,

FIGS. 3-5 current curves and voltage curves during different commutation processes,

FIG. 6 a simplified block diagram illustrating a control system for effectuation of the inventional method,

FIG. 7 a curve showing the change of the phase voltage during an ideal commutation process,

FIG. 8 a first curve showing the change of the phase voltage during a commutation process in a converter provided with a resonant circuit, and

FIG. 9 a second curve showing the change of the phase voltage during a commutation process in a converter provided with a resonant circuit.

### DETAILED DESCRIPTION OF PREFERRED EMBODIMENTS

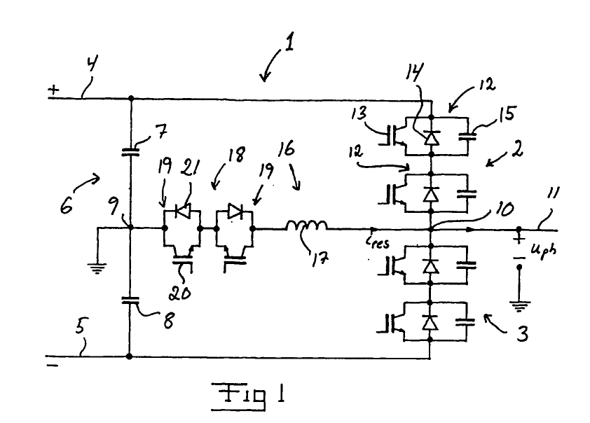

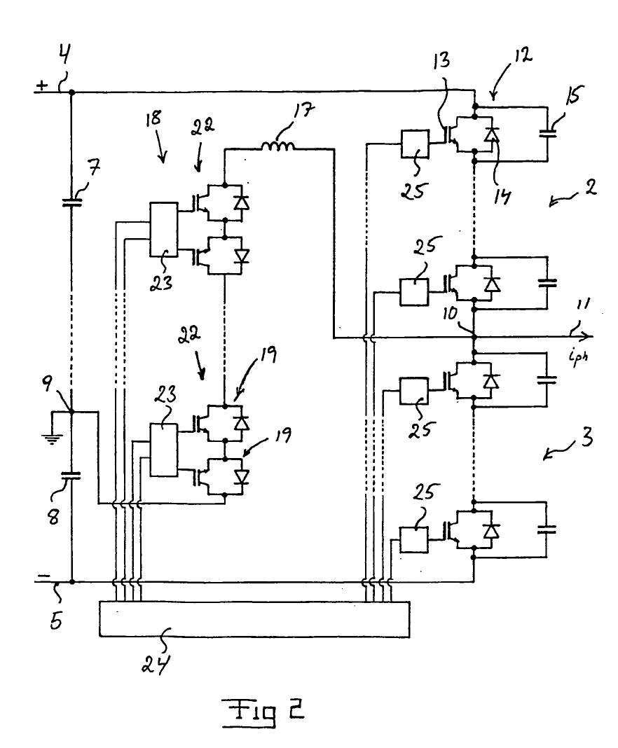

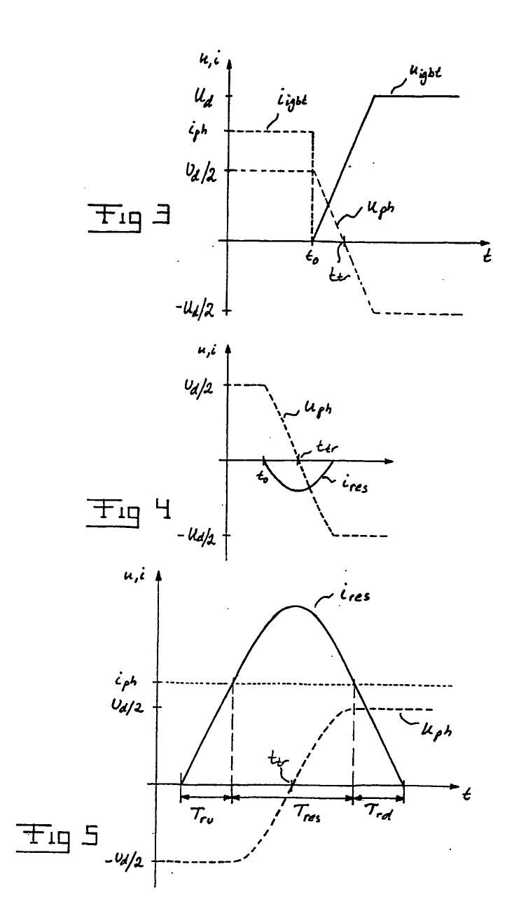

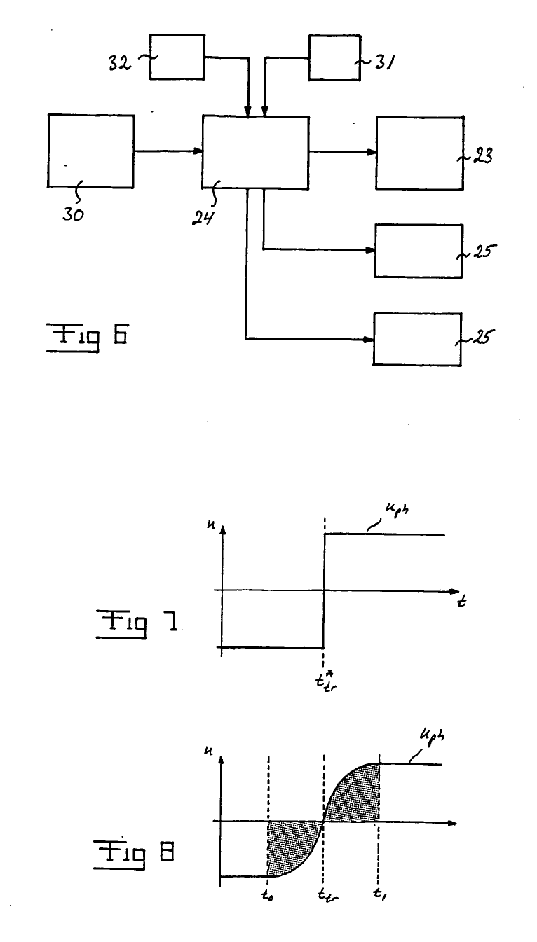

A VSC-converter is illustrated in FIG. 1. In FIG. 1, only the part of the converter that is connected to one phase of an alternating voltage phase line is shown, the number of phases normally being three, but this may also constitute the entire converter when this is connected to a single phase alternating voltage network. The shown part of the converter constitutes a so-called phase leg, and a converter adapted for instance to a three-phase alternating voltage network comprises three phase legs of the type shown.

VSC-converters are known in several designs. In all designs, a VSC-converter comprises a number of so-called current valves, each of which comprising a semiconductor element of turn-off type, such as an IGBT (Insulated Gate Bipolar Transistor) or a GTO (Gate Turn-Off Thyristor), and a rectifying member in the form of a diode, a so-called free wheeling diode, connected in anti-parallel therewith. Each semiconductor element of turn-off type is normally in high-voltage applications built up of several series connected, simultaneously controlled semiconductor components of turn-off type, such as several separate IGBT:s or GTO:s. In high-voltage applications a comparatively high number of such semiconductor components is required in order to hold the voltage to be held by each current valve in the blocking state. In the corresponding manner, each rectifying member is built up of several series connected rectifying components. The semiconductor components of turn-off type and the rectifying components are in the current valve arranged in several series connected circuits, each of which circuits comprising i.a. a semiconductor component of turn-off type and a rectifying component connected in anti-parallel therewith.

The phase leg of the converter illustrated in FIG. 1 has two current valves 2, 3 connected in series between the two poles 4, 5 of a direct voltage side of the converter. An intermediate link 6 comprising at least one so-called Intermediate link capacitor is arranged between the two poles 4, 5. In the converter illustrated in FIG. 1 the intermediate link 6 comprises two series contacted intermediate link capacitors 7, 8. A midpoint 9 between these capacitors 7, 8 is here, as customary, connected to ground, so as to provide the potentials +U_{d}/2 and −U_{d}/2, respectively, at the respective pole, U_{d} being the voltage between the two poles 4, 5. The grounding point 9 may however be excluded, for instance in SVC-applications.

A midpoint 10 of the series connection between the two current valves 2 and 3, which constitutes the phase output of the converter, is connected to an alternating voltage phase line 11. In this manner, said series connection is divided into two equal parts with a current valve 2 and 3, respectively, in each such part. In the embodiment with three phase legs, the converter consequently comprises three phase outputs, which are connected to a respective alternating voltage phase line of a three-phase alternating voltage network. The phase outputs are normally connected to the alternating voltage network via electric equipment in the form of breakers, transformers etc.

In the embodiment shown, the respective current valve 2, 3 comprises, in accordance with the above indicated, several series connected circuits 12, each of which circuits comprising a semiconductor component 13 of turn-off type, such as an IGBT, an IGCT, a MOSFET, a JFET, a MCT or a GTO, and a rectifying component 14 in the form of a diode, a so-called free wheeling diode, connected in anti-parallel therewith. In the embodiment shown in FIG. 1, each current valve 2, 3 comprises two series connected circuits 12 of the type described above, but the series connected circuits 12 may be larger as well as smaller in number. Depending i.a. on the voltage for which the converter is designed, the number of said series connected circuits 12 in the respective current valve 2, 3 may extend from two up to several hundred.

Each of the series connected circuits 12 of the respective current valve 2, 3 is provided with a capacitor 15, here denominated snubber capacitor, connected in parallel with the semi-conductor component 13 of turn-off type included in the circuit. The capacitance of the respective snubber capacitor 15 must be so high that a good voltage distribution between the semiconductor components 13 of turn-off type included in the respective current valve is made possible in connection with turn-off of the semiconductor components of turn-off type of a current valve. The choice of capacitance of the snubber capacitors 15 is adapted from case to case and depends i.a. on the current-handling capacity of the semiconductor components 13 of turn-off type and the rectifying components 14. The snubber capacitors 15 help to limit the turn-off losses of the current valves, i.e. the losses in the semiconductor components of turn-off type when these are turned off.

When the semiconductor components 13 of a current valve are turned off, the snubber capacitors 15 that are connected across these semiconductor components 13 will be charged. If the snubber capacitors 15 keep this charge when the semiconductor components 13 subsequently are turned on, turn-on losses will ensue in the semiconductor components 13. The relatively high capacity snubber capacitors 15 that will come into question in this connection will in this case cause very high turn-on losses, which turn-on losses make the use of high switching frequencies impossible. In order to eliminate or at least reduce these turn-on losses, and make possible the use of high switching frequencies, the snubber capacitors 15 are included in a resonant circuit 16. Hereby, it will be possible to accomplish discharge of the snubber capacitors 15 of a current valve when the semiconductor components 13 of the current valve are to be turned on, so that the voltage across the respective semiconductor component 13 is equal to or close to zero when it is turned on, whereby the turn-on losses are limited.

It is also possible to include a capacitor arranged between the phase output 10 and the midpoint 9 of the direct voltage intermediate link in the resonant circuit 16.

The resonant circuit 16 is here of so-called quasi-resonant type, which implies that the resonance only is initiated when the current is to be commutated between two current valves, i.e. when the voltage on the phase output is to be changed-over. Resonant circuits of this type are well known in several designs. The use of a quasi-resonant so-called ARCP-circuit of the design illustrated in FIG. 1 is for instance described in U.S. Pat. No. 5,047,913. Even though the inventional method will be exemplified below applied to a two-level ARCP-converter, it is emphasized that the method also is applicable for controlling any other converter of the type “soft switched converter” provided with a resonant circuit, such as for instance converters of the previously exemplified designs.

In the type of converter here in question, a resonant circuit comprising at least one inductor and an auxiliary valve provided with semiconductor components of turn-off type is used for recharging the snubber capacitors of the current valves in connection with communication of the phase current.

In this description and the subsequent claims, the expression auxiliary valve refers to a current valve included in the resonant circuit 16 of the converter.

In the embodiment shown In FIG. 1, the resonant circuit 16 comprises a series connection of an inductor 17 and an auxiliary valve 18 arranged between the phase output 10 and the midpoint 9 of said series connection of intermediate link capacitors 7, 8. The auxiliary valve 18 here comprises a set of two series connected auxiliary valve circuits 19, each of which comprising a semiconductor component 20 of turn-off type, such as an IGBT, an IGCT, a MOSFET, a JFET, a MCT or a GTO, and a rectifying component 21 in the form of a diode connected in anti-parallel therewith. The semiconductor components 20 of turn-off type of the two auxiliary valve circuits 19 are arranged in opposite polarity in relation to each other. This auxiliary valve 18 constitutes a bi-directional valve that can be made to conduct in one or the other direction.

The auxiliary valve 18 may also comprise several series connected sets of auxiliary valve circuits if considered appropriate, as illustrated in FIG. 2. In the embodiment illustrated in FIG. 2, the resonant circuit comprises an auxiliary valve 18 comprising several series connected sets 22 of auxiliary valve circuits, each set comprises two series connected auxiliary valve circuits 19 of the type described above. Only two series connected sets 22 of auxiliary valve circuits of the auxiliary valve 18 are shown in FIG. 2, but the number of such sets may be considerably larger than that. The number of sets of auxiliary valve circuits in the auxiliary valve 18 may be optimised independently of the number of series connected circuits 12 in the current valves 2, 3, and depends i.a. on the voltage the auxiliary valve is to be able to hold in the blocking state and the characteristics of the individual semiconductor components 20 that are being used. Generally, it can be observed that the auxiliary valve 18 in the blocking state only has to hold half the pole voltage, i.e. U_{d}/2, in contrast to the current valves 2, 3, which each has to be dimensioned so as to be able to hold the entire pole voltage U_{d} in the blocking state.

Each set 22 of auxiliary valve circuits 19 in the auxiliary valve 18 is suitably, as illustrated in° FIG. 2, provided with its own control unit 23, which is adapted to control the turn-on and turn-off of the semiconductor components 20 of turn-off type included in the set, all control units 23 of the auxiliary valve being connected to a common control device 24, which is adapted to send control signals to all these control units 23. Hereby, a simultaneous control of all the auxiliary valve circuits 19 of the auxiliary valve is secured.

It is further preferred that each of the semiconductor components 13 of turn-off type included in the current valves 2, 3 of the converter, as illustrated in FIG. 2, is provided with its own control unit 25, which is adapted to control the turn-on and turn-off of the semiconductor components 13, all control units 25 of the current valves being connected to a common control device 24, which is adapted to send control signals to all the control units 25 included in a current valve 2, 3. Hereby, a simultaneous control of all the semiconductor components 13 of a current valve is secured. The control units 23 of the auxiliary valve and the control units 25 of the current valves are here connected to one and the same control device 24, which is to be preferred.

There are three basic processes for commutation of the phase current in a converter of the type illustrated in FIGS. 1 and 2, which basic processes will be briefly described in the following.

The current valve which is current carrying in the initial state, i.e. when the commutation process is initiated, is in this description and the subsequent claims denominated “the first current valve”, and the current valve which is to be made current carrying by the commutation is denominated “the second current valve”. It is realized that the one of the two current valves 2, 3 illustrated in FIGS. 1 and 2 that at each specific commutation occasion constitutes “the first” current valve and “the second” current valve, respectively, will vary from case to case.

In this description and in the subsequent claims, the expression “a commutation not assisted by the resonant circuit” implies that the series connection of auxiliary valve 18 and inductor 17 included in the resonant circuit does not take part in the commutation process. However, the capacitive members, i.e. the snubber capacitors 15, will of course take part in this commutation process. In the corresponding manner, the expression “a commutation assisted by the resonant circuit” implies that the series connection of auxiliary valve 18 and inductor 17 included in the resonant circuit is taking part in the commutation process.

A first commutation process implies commutation of the phase current from a semiconductor element of turn-off type of a current carrying first current valve 2, 3 to a rectifying member of a second current valve 3, 2 without any assistance of the resonant circuit 16. The commutation process is initiated in that the semiconductor element of turn-off type of the first current valve is turned off, whereupon the phase current iₚₕ produces a charging of the capacitive members of the first current valve, i.e. its snubber capacitors 15, and a discharge of the capacitive members of the second current valve, i.e. its snubber capacitors 15. The phase potential will hereby swing from one pole to the other pole. In FIG. 3 the change of the current i_{ight} and the voltage u_{ight} of the semiconductor element of turn-off type of the first current valve during the commutation process is illustrated. The semiconductor element of turn-off type of the first current valve is turned off at the instant t₀, whereupon the current through the semiconductor element in the ideal case directly goes down to zero. In reality the semiconductor element will have a certain reverse recovery current. The phase current iₚₕ will thereafter produce a charging of the capacitive members of the first current valve, the voltage thereacross and thereby across the semiconductor element of turn-off type increasing essentially linearly from zero up to a value U_{d} corresponding to the voltage between the poles 4, 5. It is realized that the turn-off of the semiconductor element of the first current valve may take place essentially without any power dissipations.

The duration T_{I} of this commutation process is in the ideal case given by the formula

$${T}_{I} = \frac{{C}_{s} \cdot {U}_{d}}{\vert {i}_{p h} \vert}$$

where U_{d} is the voltage across the series connection 6 of intermediate link capacitors, iₚₕ is the phase current and Cₛ is the snubber capacitance, i.e. the sum of total, series connected snubber capacitance for one valve 2, total, series connected snubber capacitance for the other valve 3 and, whenever applicable, the capacitance of the capacitor arranged between the phase output 10 and the midpoint 9 of the intermediate link.

A second commutation process implies commutation of the phase current from a semiconductor element of turn-off type of a current carrying first current valve 2, 3 to a rectifying member of a second current valve 3, 2 with the assistance of the resonant circuit 16. This commutation process is used at low phase currents in order to accelerate the commutation. The commutation process is initiated by turning on the semiconductor component of turn-off type (the embodiment according to FIG. 1), or whenever applicable the semiconductor components of turn-off type (the embodiment according to FIG. 2), to which voltage Is (are) applied in the auxiliary valve. At the same time as the semiconductor component(-s) of the auxiliary valve is (are) turned on, the semiconductor element of the first current valve is turned off. In case so-called boost current is used in connection with the commutation, the semiconductor element of turn-off type of the first current valve is turned off somewhat after the instant the semiconductor component(-s) of the auxiliary valve is (are) turned on. In the following, it is assumed that a method without use of boost current is utilized. A resonance period will now follow, during which the resonant circuit provides to the phase output 10 a current conducing to the charging of the snubber capacitors 15 of the first current valve and discharging of the snubber capacitors 15 of the second current valve. After the voltage across the second current valve has fallen to zero or to a value close to zero, the semiconductor element of turn-off type of the second current valve is turned on. After the current in the resonant circuit has fallen to zero or to a value close to zero, the semiconductor component(-s) 20 of turn-off type that was (were) initially turned on In the auxiliary valve 18 is (are) turned off.

In a case with a balanced intermediate link, i.e. when the voltages u_{d1} and u_{d2} across the intermediate link capacitors are equally large (u_{d1}=u_{d2}=U_{d}/2), the duration T_{II} of this commutation process is given by the formula:

$${T}_{II} = \frac{1}{{ω}_{0}} [ π - 2 arctan ( \frac{2 {Z}_{0} \cdot \vert {i}_{p h} \vert}{{U}_{d}} ) ] .$$

In the aboveindicated formula

$${ω}_{0} = \frac{1}{\sqrt{{L}_{res} \cdot {C}_{s}}} and {Z}_{0} = \sqrt{\frac{{L}_{res}}{{C}_{s}}} , {L}_{res}$$

being the value of the inductance of the resonant circuit and Cₛ, as previously mentioned, being the snubber capacitance.

The aboveindicated formula for T_{II} is suitably adapted for a case with an unbalanced intermediate link, i.e. when the voltages u_{d1} and u_{d2} across the intermediate link capacitors are differently large.

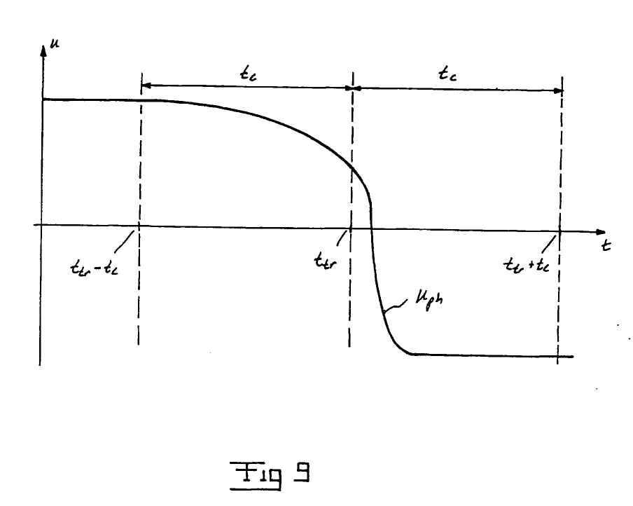

FIG. 4 illustrates the change of the current iᵣₑₛ through the resonant circuit and the phase voltage uₚₕ during the abovedescribed commutation process. The semiconductor component(-s) of turn-off type of the auxiliary valve 18 is (are) turned on at the instant t₀. In the case illustrated in FIG. 4, no boost current is used, wherefore the semiconductor element of turn-off type of the first current valve is turned off at the same instant t₀.

A third commutation process implies commutation of the phase current from a rectifying member of a current carrying first current valve 2, 3 to a semiconductor element of turn-off type of a second current valve 3, 2 with the assistance of the resonant circuit 16. The commutation process is initiated by turning on the semiconductor component of turn-off type (the embodiment according to FIG. 1), or whenever applicable the semiconductor components of turn-off type (the embodiment according to FIG. 2), to which voltage is (are) applied in the auxiliary valve, whereupon a so-called ramp-up period is initiated. During the ramp-up period the current In the resonant circuit will, under the influence of the voltage u_{d1}, u_{d2} across one of the two intermediate link capacitors 7, 8, increase from zero to a value corresponding to the phase current iₚₕ. In the ideal case the voltages u_{d1} and u_{d2} across the intermediate link capacitors are equally large, but they may in practice differ somewhat from each other. The duration Tᵣᵤ of the ramp-up period is in the ideal case given by the formula

$${T}_{ru} = \frac{{L}_{res} \cdot \vert {i}_{p h} \vert}{{u}_{dl}}$$

where Lᵣₑₛ is the value of the inductance of the resonant circuit and u_{d1} corresponds to the voltage u_{d1} between a first 4 of the poles and the midpoint 9 of the intermediate link capacitors, i.e. the voltage across the intermediate link capacitor 7, when the phase current iₚₕ is commutated from a current valve 2 arranged between said first pole 4 and the phase output 10 to a current valve 3 arranged between the second pole 5 and the phase output 10, whereas u_{d1} corresponds to the voltage u_{d2} between the midpoint 9 of the intermediate link capacitors and the second pole 5, i.e. the voltage across the intermediate link capacitor 8, when the phase current iₚₕ is commutated from a current valve 3 arranged between the second pole 5 and the phase output 10 to a current valve 2 arranged between the first pole 4 and the phase output 10. In the ideal case Lᵣₑₛ corresponds to the value of the inductance of the inductor of the resonant circuit, but in practice the inductance Lᵣₑₛ of the resonant circuit is also effected by the inductances of the other components of the resonant circuit.

When the current through the resonant circuit reaches a value corresponding to the phase current iₚₕ, a resonance period begins, during which the snubber capacitors 15 of the first current valve are being charged and the snubber capacitors 15 of the second current valve are being discharged. When the voltage across the second current valve has fallen to zero or to a value close to zero, the semiconductor component of turn-off type of the second current valve is turned on. The duration Tᵣₑₛ of the resonance period is in the ideal case given by the formula

$${T}_{res} = \frac{π}{{ω}_{0}} where {ω}_{0} = \frac{1}{\sqrt{{L}_{res} \cdot {C}_{s}}} .$$

After the resonance period a so-called ramp-down period begins, during which the current in the resonant circuit decreases to zero from a value corresponding to the phase current iₚₕ. The duration T_{rd} of the ramp-down period is in the ideal case given by the formula

$${T}_{r d} = \frac{{L}_{res} \cdot \vert {i}_{p h} \vert}{{u}_{dj}}$$

where u_{dj} corresponds to the voltage u_{d2} between the midpoint 9 of the intermediate link capacitors and the second pole 5, i.e. the voltage across the intermediate link capacitor 8, when the phase current iₚₕ is commutated from a current valve 2 arranged between the first pole 4 and the phase output 10 to a current valve 3 arranged between the second pole 5 and the phase output 10, whereas u_{dj} corresponds to the voltage u_{d1} between the first pole 4 and the midpoint 9 of the intermediate link capacitors, i.e. the voltage across the intermediate link capacitor 7, when the phase current iₚₕ is commutated from a current valve 3 arranged between the second pole 5 and the phase output 10 to a current valve 2 arranged between the first pole 4 and the phase output 10.

When the ramp-down period is over and the current has fallen to zero in the resonant circuit, the semiconductor component(-s) 20 of turn-off type that was (were) Initially turned on in the auxiliary valve 18 is (are) turned off.

FIG. 5 illustrates the change of the current iᵣₑₛ through the resonant circuit and the phase current uₚₕ during the abovedescribed commutation process.

The control device 24 is supplied with signals representing the desired commutation instants t*ₜᵣ from a modulator 30, schematically illustrated in FIG. 6, which preferably is a PWM-modulator (PWM=Pulse Width Modulation). In an ideal case an ordered commutation will take place directly in one single step at the commutation instant t*ₜᵣ given by the modulator, as illustrated in FIG. 7, i.e. the phase voltage will in one single step change from one pole voltage to the other. In a converter provided with a resonant circuit, the phase potential will however change relatively slowly during a commutation process, as exemplified in FIG. 8. The instant that is relevant with respect to the generation of control signals in the modulator 30 is in FIG. 8 indicated with tₜᵣ and is here denominated the equivalent transition instant. This instant tₜᵣ represents the instant when the transition of the phase voltage from one pole voltage to the other can be said to occur. For the converter to operate in an optimal manner, the converter should be controlled so that the commutation instant t*ₜᵣ given by the modulator will correspond with the equivalent transition instant tₜᵣ.

The equivalent transition instant tₜᵣ can be defined as follows:

When the transition of the phase voltage uₚₕ(t), i.e. the change of the phase voltage uₚₕ(t) in time, during a commutation process is “symmetric” about the time axis, the equivalent transition instant tₜᵣ coincides with the zero crossing of the phase voltage. Such a “symmetric” case is illustrated in FIG. 8.

When the transition of the phase voltage μₚₕ(t) during a commutation process is not “symmetric” about the time axis, the equivalent transition instant tₜᵣ is given by the following condition

$${\int }_{{t}_{tr} - {t}_{c}}^{{t}_{tr} + {t}_{c}} {u}_{p h} ( t ) ⅆ t = 0$$

where t_{c} is so chosen that the transition of the phase voltage uₚₕ(t) has not began at the instant tₜᵣ−t_{c} and has been completed at the instant tₜᵣ+t_{c}. An example of such a “non-symmetric” transition of the phase voltage uₚₕ(t) during a commutation process is illustrated in FIG. 9.

The transition of the phase voltage uₚₕ(t) during a commutation process is “symmetric” In those cases where

uₚₕ(t₀+τ)=−uₚₕ(t−τ), for 0<τ<(t₁−t₁)/2,

where t₀ represents the instant when the transition, i.e. the change, of the phase voltage uₚₕ(t) has began and t₁ represents the instant when the transition has been completed.

The equivalent transition instant tₜᵣ can be estimated on the basis of knowledge about the influence the components included in the converter have on the transition of the phase voltage uₚₕ(t) during a commutation process.

The control device 24 is according to the invention, in connection with effectuation of an intended commutation process ordered by the modulator 30, made to send control signals to the current valves 2, 3 and auxiliary valve 18 that are taking part in the commutation process, for turning on or turning off thereof, at instants t₁ determined on the basis of a desired commutation instant t*ₜᵣ given by the modulator 30 and a calculation algorithm, which is based upon knowledge about the influence the components included in the converter have on the intended commutation process and the input data of which are the values of the phase current iₚₕ and the intermediate link voltage, said calculation algorithm being elaborated in consideration of the condition that the desired commutation instant t*ₜᵣ is to coincide with the equivalent transition instant tₜᵣ for the phase voltage.

Said calculation algorithm is suitably based upon the value of the inductance Lᵣₑₛ of the resonant circuit 16, the value of the snubber capacitance Cₛ, and measured values of the intermediate link voltage u_{d1} and u_{d2}, respectively, and the phase current iₚₕ. By means of these parameters it is possibly, with sufficient accuracy, to determine the instants t₁ at which the control device 24 is to send control signals to the current valves and the auxiliary valve of the converter in order for the semiconductor elements of turn-off type of the current valves and the semiconductor components of turn-off type of the auxiliary valve to be made to turn on and turn off at instants suitable for the different commutation processes.

The present phase current iₚₕ at the commutation instant is registered by a suitable means for current measuring, schematically indicated at 31 in FIG. 6, which means is adapted to transmit measuring signals to the control device 24.

The converter suitably comprises means for measuring the voltage u_{d1} across the respective intermediate link capacitor 7, 8, schematically indicated at 32 in FIG. 6, which means is adapted to transmit measuring signals to the control device 24. In case a lower accuracy in the control of the commutation processes can be accepted for a specific converter, one may make the assumption that the voltage across the respective intermediate link capacitor corresponds to half the pole voltage, as in the ideal case, in which case said means 32 for voltage measuring can be excluded.

The values of the parameters used in the abovementioned calculation algorithm, such as the snubber capacitance Cₛ and the inductance Lᵣₑₛ, are suitably determined by measurings performed on the converter after the converter has been assembled. These measurings may with advantage be carried out repeatedly during the service life of the converter, in order to compensate for changes of said values. Hereby, it is secured that the gradual changes of said values arising due to the degenerations of the components of the resonant circuit appearing in course of time will not have any detrimental effect on the control of the commutation processes. The values of the snubber capacitance Cₛ, the inductance Lᵣₑₛ and the other parameters used in the calculation of the instants t₁ may with advantage be determined by recursive identification, which implies that the values of these parameters continuously are updated and adjusted based upon measurings performed during previous commutation processes.

According to a preferred embodiment of the invention, the variation of the phase current iₚₕ during the respective commutation process is taken into consideration in the calculation of the instants t₁ for sending control signals from the control device 24. Hereby, an increased precision in the control is obtained. The varying value of the phase current during the commutation process is suitably estimated by means of a linear model of the load connected to the phase output 10.

Suitable algorithms for determination of the instants t₁ for sending control signals from the control device 24 to the current valves 2, 3 and the auxiliary valve 18 of a ARCP-converter in connection with the previously described types of commutation processes are given below.

At a commutation, not assisted by the resonant circuit, of the phase current iₚₕ from a semiconductor element of turn-off type of a first current valve 2, 3 to a rectifying member of a second current valve 3, 2, the control device may be adapted to send:

a turn-off signal to the first current valve at a first instant i_{I1} given by the formula

$${t}_{l 1} = {t}_{tr}^{*} - \frac{1}{2} {T}_{I} - {t}_{d 1}$$

where t_{d1} is the estimated time delay from the instant the turn-off signal is sent from the control device 24 to the instant the turn-off of the semiconductor element of the first current valve is effectuated, and

a turn-on signal to the second current valve at or after a second instant t_{I2} given by the formula

$${t}_{I 2} = {t}_{tr}^{*} + \frac{1}{2} {T}_{I} - {t}_{d 2}$$

where t_{d2} is the estimated time delay from the instant the turn-on signal is sent from the control device 24 to the instant the turn-on of the semiconductor element of the second current valve is effectuated.

In the aboveindicated formulas for t_{I1} and t_{I2}, T_{I} is the duration of the commutation process in question, preferably estimated in accordance with the previously indicated formula.

For an increased accuracy of the control, it may also be appropriate to take the reverse recovery of the semiconductor element of the first current valve into consideration, and adjust the calculation of the duration T_{I} and thereby the calculations of the instants t_{I1} and t_{I2} in consideration of this reverse recovery. The influence of the reverse recovery on the commutation process is suitably determined by measurings performed on the converter after it has been assembled, which measurings may be repeated during the service life of the converter in order to compensate for changes of the reverse recovery caused by degenerations of the components of the converter.

At a commutation process implying a commutation assisted by the resonant circuit of the phase current iₚₕ from a semiconductor element of turn-off type of a first current valve 2, 3 to a rectifying member of a second current valve 3, 2, the control device 24 may be adapted to send:

a turn-on signal to the auxiliary valve 18 at a first instant t_{II1} given by the formula

$${t}_{II 1} = {t}_{tr}^{*} - \frac{1}{2} {T}_{II} - {t}_{d 3}$$

where t_{d3} is the estimated time delay from the instant the turn-on signal is sent from the control device 24 to the instant the turn-on of the intended semiconductor component of the auxiliary valve 18 is effectuated,

a turn-off signal to the first current valve at or before a second instant t_{II2} given by the formula

$${t}_{II 2} = {t}_{tr}^{*} - \frac{1}{2} {T}_{II} - {t}_{d 4}$$

where t_{d4} is the estimated time delay from the instant the turn-off signal is sent from the control device 24 to the instant the turn-off of the semiconductor element of the first current valve is effectuated,

a turn-on signal to the second current valve at a third instant t_{II3} given by the formula

$${t}_{II 3} = {t}_{tr}^{*} + \frac{1}{2} {T}_{II} - {t}_{d 5}$$

where t_{d5} is the estimated time delay from the instant the turn-on signal is sent from the control device 24 to the instant the turn-on of the semiconductor element of the second current valve is effectuated, and

a turn-off signal to the auxiliary valve 18 at or after a fourth instant t_{II4} given by the formula

$${t}_{II 4} = {t}_{tr}^{*} + \frac{1}{2} {T}_{II} - {t}_{d 6}$$

where t_{d6} is the estimated time delay from the instant the turn-off signal is sent from the control device 24 to the instant the turn-off of the intended semiconductor component of the auxiliary valve 18 is effectuated.

In case t_{d4} is larger than or equal to t_{d3}, the control device 24 may of course be adapted to send the turn-off signal to the first current valve simultaneously with the turn-on signal to the auxiliary valve. In the same manner, the control device 24 may be adapted to send the turn-off signal to the auxiliary valve simultaneously with the turn-on signal to the second current valve in case t_{d6} is larger than or equal to t_{d5}.

In the aboveindicated formulas for t_{II1}, t_{II2}, t_{II3} and t_{II4}, T_{II} is the duration of the commutation process in question, preferably estimated in accordance with the previously indicated formula.

For increased accuracy of the control, it may also be appropriate to take the reverse recovery of the semiconductor element of the first current valve and/or the power dissipations in the resonant circuit and/or unequalities in the voltage distribution between the intermediate link capacitors into consideration and adjust the calculation of the duration T_{II} and thereby the calculations of the instants t_{II1}, t_{II2}, t_{II3}, and t_{II4} in consideration of these factors. The influence of said factors on the commutation process is suitably determined by measurings performed on the converter after it has been assembled, which measurings may be repeated during the service life of the converter in order to compensate for changes caused by degenerations of the components of the converter.

At a commutation process implying a commutation assisted by the resonant circuit of the phase current iₚₕ from a rectifying member of a first current valve 2, 3 to a semiconductor element of turn-off type of a second current valve 3, 2, the control device 24 may be adapted to send:

a turn-on signal to the auxiliary valve 18 at a first instant t_{III1} given by the formula

$${t}_{III 1} = {t}_{tr}^{*} - {T}_{ru} - \frac{1}{2} {T}_{res} - {t}_{d 7}$$

where t_{d7} is the estimated time delay from the instant the turn-on signal is sent from the control device 24 to the instant the turn-on of the Intended semiconductor component of the auxiliary valve 18 is effectuated,

a turn-off signal to the first current valve at or before a second instant t_{III2} given by the formula

$${t}_{III 2} = {t}_{tr}^{*} - {T}_{ru} - \frac{1}{2} {T}_{res} - {t}_{d 8}$$

where t_{d8} is the estimated time delay from the instant the turn-off signal is sent from the control device 24 to the instant the turn-off of the semiconductor element of the first current valve is effectuated,

a turn-on signal to the second current valve at a third instant t_{III3} given by the formula

$${t}_{III 3} = {t}_{tr}^{*} + \frac{1}{2} {T}_{res} - {t}_{d 9}$$

where t_{d9} is the estimated time delay from the instant the turn-on signal is sent from the control device 24 to the instant the turn-on of the semiconductor element of the second current valve is effectuated, and

a turn-off signal to the auxiliary valve 18 at or after a fourth instant t_{III4} given by the formula

$${t}_{III 4} = {t}_{tr}^{*} + \frac{1}{2} {T}_{res} + {T}_{r d} - {t}_{d 10}$$

where t_{d10} is the estimated time delay from the instant the turn-off signal is sent from the control device 24 to the instant the turn-off of the intended semiconductor component of the auxiliary valve 18 is effectuated.

In case t_{d8} is larger than or equal to t_{d7} the control device 24 may of course be adapted to send the turn-off signal to the first current valve simultaneously with the turn-on signal to the auxiliary valve. In the same manner, the control device 24 may be adapted to send the turn-off signal to the auxiliary valve simultaneously with the turn-on signal to the second current valve in case t_{d10} is larger than or equal to t_{d9}.

In the aboveindicated formulas for t_{III1}, t_{III2}, t_{III3} and t_{III4}, Tᵣₑₛ is the duration of the resonance period, Tᵣᵤ the duration of the ramp-up period and T_{rd} the duration of the ramp-down period, preferably estimated in accordance with the previously indicated formulas.

For increased accuracy of the control, it may also be appropriate to take the reverse recovery of the rectifying members of the current valves and/or the power dissipations in the resonant circuit and/or the unequalities in the voltage distribution between the intermediate link capacitors 7, 8 into consideration and adjust the calculation of the durations Tᵣᵤ, T_{rd} and Tᵣₑₛ and thereby the calculations of the instants t_{III1}, t_{III2}, t_{III3} and t_{III4}, in consideration of these factors. The influence of these factors on the commutation process is suitable determined by measurings performed on the converter after it has been assembled, which measurings may be repeated during the service life of the converter in order to compensate for changes caused by degenerations of the components of the converter.

The above indicated time delays t_{d1}−t_{d10} may be functions of different variables, mainly the phase current. The time delays t_{d1}−t_{d10} at different values of the phase current may for instance be determined by measurings performed on the converter after it has been assembled. These measurings may with advantage be repeated during different occasions during the service life of the convert in order to compensate for changes of said time delays caused for instance by degenerations of the components of the converter.

The basis for the above indicated formulas for determination of the instants t₁ is that the commutation instant t*ₜᵣ given by the modulator 30 is to correspond with the above described equivalent transition instant tₜᵣ with required accuracy.

It is realized that the turn-off and turn-on, respectively, of the semiconductor element of turn-off type of a current valve as described above and as indicated in the claims, refer to the simultaneous turn-off and turn-on, respectively, of all the semiconductor components 13 of turn-off type of a current valve in those cases where the respective current valve comprises several series connected circuits 12 of previously indicated type. It is likewise realized that the turn-off and turn-on, respectively, of the semiconductor component of turn-off type of an auxiliary valve as described above and as indicated in the claims, in those cases where the auxiliary valve 18 comprises several series connected sets 22 of auxiliary valve circuits 19 of previously described type, refer to the simultaneous turn-off and turn-on, respectively, of all the semiconductor components 20, to which voltage is applied or which are current carrying, of an auxiliary valve.

The invention is of course not in any way restricted to the preferred embodiments described above, on the contrary many possibilities to modifications thereof should be apparent to a person skilled in the art without departing from the basic idea of the invention as defined in the appended claims.

1. A method for controlling a VSC converter, which converter comprises
a series connection of at least two current valves arranged between two poles a positive and a negative, of a direct voltage side of the converter, each of which current valves comprising a semiconductor element of turn-off type and a rectifying member connected in anti-parallel therewith, an alternating voltage phase line being connected to a midpoint denominated phase output, of the series connection between two current valves while dividing the series connection into two equal parts,
an intermediate link arranged on the direct voltage side of the converter, which intermediate link comprises at least one intermediate link capacitor,
a resonant circuit comprising at least a capacitive member, an inductor and an auxiliary valve provided with semiconductor components of turn-off type for recharging said capacitive member in connection with commutation of the phase current,
a control device for controlling turn-on and turn-off of the semiconductor elements of turn-off type of the current valves and the semiconductor components of turn-off type of the auxiliary valve, and
means for measuring the phase current,
said turn-on and turn-off being controlled by the control device in dependence on control signals received from a modulator, which signals indicate desired instants for commutation,
wherein the control device, in connection with the effectuation of an intended commutation process ordered by the modulator, sends control signals to the current valves and auxiliary valve that are taking part in the commutation process, for turning on or turning off thereof, at instants determined on the basis of a desired commutation instant given by the modulator and a calculation algorithm, which is based upon knowledge about the influence the components included in the converter have on the intended commutation process, said calculation algorithm being elaborated in consideration of the condition that the desired commutation instant is to coincide with an equivalent transition instant for the phase voltage, which equivalent transition instant is given by the condition
$${\int }_{{t}_{tr} - {t}_{c}}^{{t}_{tr} = {t}_{c}} {u}_{p h} ( t ) ⅆ t = 0$$
where uₚₕ(t) is the phase voltage, tₜᵣ is the equivalent transition instant and t_{c} is so chosen that the changing of the phase voltage (uₚₕ(t)) has not began at the instant tₜᵣ−t_{c} and has been completed at the instant tₜᵣ+t_{c}.

2. The method according to claim 1, wherein the value of the intermediate link voltage, the value of the phase current, the value of the snubber capacitance and the value of the inductance of the resonant circuit is taken into consideration in said calculation algorithm.

3. The method according to claim 2, wherein the value of the inductance of the resonant circuit and/or the value of the snubber capacitance is determined by measurings performed on the converter.

4. The method according to claim 3, wherein the measurings for determining the value of the inductance of the resonant circuit and/or the value of the snubber capacitance are performed repeatedly during the service life of the converter in order to compensate for changes of these values.

5. The method according to claim 3, wherein the value of the inductance of the resonant circuit and/or the value of the snubber capacitance is continuously updated and adjusted based upon measurings performed during previous commutation processes.

6. The method according to claim 2, wherein the value of the voltages across the intermediate link capacitors is determined by continuous measurings.

7. The method according to claim 2, wherein the variation of the phase current during the intended commutation process is taken into consideration in said calculation algorithm.

8. The method according to claim 7, wherein a linear model of the load connected to the phase output is used in order to describe the variation, of the phase current during the intended commutation process.

9. The method according to in that claim 1, wherein parameter values included in the calculation algorithm are continuously updated and adjusted based upon measurings performed during previous commutation processes.

10. The method according to claim 1, wherein the converter is an ARCP-converter, the intermediate link comprising a series connection of at least two intermediate link capacitors arranged between the two poles of the direct voltage side of the converter, and the resonant circuit comprising a series connection of an inductor and an auxiliary valve arranged between the phase output and a midpoint of said series connection of intermediate link capacitors said auxiliary valve comprising at least two semiconductor components of turn-off type arranged in opposite polarity in relation to each other, the resonant circuit further comprising capacitive members, each of which being connected in series with said inductor and auxiliary valve and in parallel with one of said current valves.

11. The method according to claim 10, wherein at a commutation process implying a commutation, not assisted by the resonant circuit, of the phase current from a semiconductor element of turn-off type of a first current valve to a rectifying member of a second current valve, the control device is made to send:
a turn-off signal to the first current valve at a first instant given by the formula
(t_{II})=t*ₜᵣ−½T_{I}−t_{d1}
where t_{II} is said first instant, t*ₜᵣ the desired commutation instant given by the modulator, T_{I} the estimated duration of the commutation process, and t_{d1} the estimated time delay from the instant the turn-off signal is sent from the control device to the instant the turn-off of the semiconductor element of the first current valve is effectuated, and
a turn-on signal to the second current valve at or after a second instant given by the formula
(t_{I2})=t*ₜᵣ−½T_{I}−t_{d2}
where t_{I2} is said second instant and t_{d2} the estimated time delay from the instant the turn-on signal is sent from the control device to the instant the turn-on of the semiconductor element of the second current valve is effectuated.

12. The method according to claim 11, wherein T_{I} is given by the formula
$${T}_{I} = \frac{{C}_{s} \cdot {U}_{d}}{\vert {i}_{p h} \vert}$$
where iₚₕ is the phase current, Cₛ the snubber capacitance and U_{d} the voltage across the intermediate link.

13. The method according to claim 12, wherein the formula for calculating T_{I} is adjusted in consideration of the reverse recovery of the semiconductor element of the first current valve.

14. The method according to claim 10, wherein at a commutation process implying a commutation, assisted by the resonant circuit, of the phase current from a semiconductor element of turn-off type of a first current valve to a rectifying member of a second current valve the control device is made to send:
a turn-on signal to the auxiliary valve at a first instant (t_{II1}) given by the formula
(t_{II1})=t*ₜᵣ−½T_{II}−t_{d3}
where t_{II1} is said first instant, t*ₜᵣ the desired commutation instant given by the modulator, T_{II} the estimated duration of the commutation process, and t_{d3} the estimated time delay from the instant the turn-on signal is sent from the control device to the instant the turn-on of the intended semiconductor component of the auxiliary valve is effectuated,
a turn-off signal to the first current valve at or before a second instant given by the formula
(t_{II2})=t*ₜᵣ−½T_{II}−t_{d4}
where t_{II2} is said second instant and t_{d4} is the estimated time delay from the instant the turn-off signal is sent from the control device to the instant the turn-off of the semiconductor element of the first current valve is effectuated,
a turn-on signal to the second current valve at a third instant given by the formula
(t_{II3})=t*ₜᵣ−1/2T_{II}−t_{d5}
where t_{II3} is said third instant and t_{d5} is the estimated time delay from the instant the turn-on signal is sent from the control device to the instant the turn-on of the semiconductor element of the second current valve is effectuated, and
a turn-off signal to the auxiliary valve at or after a fourth instant given by the formula
(t_{II4})=t*ₜᵣ−½T_{II}−t_{d6}
where t_{II4} is said fourth instant and t_{d6} is the estimated time delay from the instant the turn-off signal is sent from the control device to the instant the turn-off of the intended semiconductor component of the auxiliary valve is effectuated.

15. The method according to claim 14, wherein T_{II} is given by the formula
$${T}_{II} = \frac{1}{{ω}_{0}} [ π - 2 arctan ( \frac{2 {Z}_{0} \cdot \vert {i}_{p h} \vert}{{U}_{d}} ) ]$$
where iₚₕ is the phase current, U_{d} the voltage across the intermediate link,
$${ω}_{o} = \frac{1}{\sqrt{{L}_{res}} \cdot {C}_{s}} and {Z}_{o} = \sqrt{\frac{{L}_{res}}{{C}_{s}}} ,$$
Cₛ being the snubber capacitance and Lᵣₑₛ being the inductance of the resonant circuit.

16. The method according to claim 15, wherein the formula for calculating T_{II} is adjusted in consideration of the reverse recovery of the semiconductor element of the first current valve and/or the power dissipations in the resonant circuit and/or unequalities in the voltage distribution between the intermediate link capacitors.

17. The method according to claim 10, wherein at a commutation process implying a commutation, assisted by the resonant circuit, of the phase current from a rectifying member of a first current valve to a semiconductor element of turn-off type of a second current valve the control device is made to send:
a turn-on signal to the auxiliary valve at a first instant given by the formula
(t_{III1})=t*ₜᵣ−Tᵣᵤ−½Tᵣₑₛ−t_{d7}
where t_{III1} is said first instant, t*ₜᵣ the desired commutation instant given by the modulator, Tᵣₑₛ the estimated duration of the resonance period, Tᵣᵤ the estimated duration of the ramp-up period and t_{d7} the estimated time delay from the instant the turn-on signal is sent from the control device to the instant the turn-on of the intended semiconductor component of the auxiliary valve is effectuated,
a turn-off signal to the first current valve at or before a second instant given by the formula
(t_{III2})=t*ₜᵣ−Tᵣᵤ−½Tᵣₑₛ−t_{d8}
where t_{III2} is said second instant and t_{d8} is the estimated time delay from the instant the turn-off signal is sent from the control device to the instant the turn-off of the semiconductor element of the first current valve is effectuated,
a turn-on signal to the second current valve at a third instant given by the formula
(t_{III3})=t*ₜᵣ+½Tᵣₑₛ−t_{d9}
where t_{III3} is said third instant and t_{d9} the estimated time delay from the instant the turn-on signal is sent from the control device to the instant the turn-on of the semiconductor element of the second current valve is effectuated, and
a turn-off signal to the auxiliary valve at or after a fourth instant given by the formula
(t_{III4})=t*ₜᵣ+½Tᵣₑₛ+T_{rd}−t_{d10}
where t_{III4} is said fourth instant, T_{rd} the estimated duration of the ramp-down period and t_{d10} the estimated time delay from the instant the turn-off signal is sent from the control device to the instant the turn-off of the intended semiconductor component of the auxiliary valve is effectuated.

18. The method according to claim 17, wherein:
Tᵣᵤ is given by the formula
$${T}_{ru} = \frac{{L}_{res} \cdot \vert {i}_{p h} \vert}{{u}_{di}}$$
where Lᵣₑₛ is the inductance of the resonant circuit, iₚₕ the phase current, u_{di} the voltage between a first one of the poles and the midpoint of the intermediate link when the phase current is commutated from a current valve arranged between said first pole and the phase output to a current valve arranged between the second pole and the phase output whereas u_{di} is the voltage between the second pole and the midpoint of the intermediate link when the phase current is commutated from a current valve arranged between the second pole and the phase output to a current valve arranged between the first pole and the phase output,
T_{rd} is given by the formula
$${T}_{r d} = \frac{{L}_{res} \cdot \vert {i}_{p h} \vert}{{u}_{dj}}$$
where u_{dj} is the voltage between the second pole and the midpoint of the intermediate link when the phase current is commutated from a current valve arranged between the first pole and the phase output to a current valve arranged between the second pole and the phase output, whereas u_{dj} is the voltage between the first pole and the midpoint of the intermediate link when the phase current is commutated from a current valve arranged between the second pole and the phase output to a current valve arranged between the first pole and the phase output, and
Tᵣₑₛ is given by the formula
$${T}_{res} = \frac{π}{{ω}_{0}}$$
$$where {ω}_{0} = \frac{1}{\sqrt{{L}_{res} \cdot {C}_{s}}} .$$

19. The method according to claim 18, wherein the formula for calculating Tᵣₑₛ is adjusted in consideration of the reverse recovery of the rectifying members of the current valves and/or the power, dissipations in the resonant circuit and/or unequalities in the voltage distribution between the intermediate link capacitors.

20. The method according claim 11, wherein the respective time delay is estimated with the aid of a measured value of the phase current.

21. The method according to claim 1, wherein the control device receives the control signals that are indicating the desired commutation instants from a PWM-modulator.
